(19) United States
(12) Patent Application Publication
(10) Pub. No.: US 2008/0216932 A1
(43) Pub. Date: Sep. 11, 2008

(54) PNEUMATIC TIRE AND METHOD FOR MANUFACTURING THE SAME

(75) Inventors: Yuji Fujikawa, Osaka (JP); Takashi Nakatsuru, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/034,749

(22) Filed: Feb. 21, 2008

(30) Foreign Application Priority Data
Mar. 8, 2007 (JP) 2007-59123

(51) Int. Cl. B60C 5/00; B29C 43/00

(52) U.S. Cl. 152/450; 264/319

(57) ABSTRACT

A pneumatic tire is provided in which the degree of freedom in designing markings shown on external surfaces thereof is enhanced without depending upon engraved letters on a conventional mold so as to meet requests from individual users while increasing the visibility of the markings so shown. In a pneumatic tire having markings on external surfaces thereof, thermoplastic resin films of which a center line average surface roughness (Ra) of a surface is in the range of 0.1 to 1.5 μm are affixed to predetermined positions on external surfaces of a green tire of the tire and the green tire is then vulcanization molded, whereby markings are formed. Surfaces of the markings are made up of a specular surface of which Ra is in the range of 0.1 to 1.5 μm, and a background portion 11 which surrounds peripheries of the markings is made up of a rough surface of which Ra exceeds 1.5 μm.

### CROSS-REFERENCE TO RELATED APPLICATIONS

This application is based upon and claims the benefit of priority from the prior Japanese Patent Application No. 2007-59123, filed on Mar. 8, 2007, the entire contents of which are incorporated herein by reference.

### BACKGROUND OF THE INVENTION

1. Field of the Invention

The present invention relates to a pneumatic tire and more particularly to a pneumatic tire having provided on the surfaces of side walls thereof markings such as letters, numbers, symbols or graphics which are easy to be formed and superior in visibility.

2. Description of Background Art

In general, markings are shown on external surfaces of side walls of a pneumatic tire which are made up of letters, numbers and symbols which designate a manufacturer, a trade name, a tire size and the like, as well as graphics such as design patterns which indicate the rotational direction of the tire and make the sides of the tire appear better, and it is important that the markings so shown have superior visibility to be attractive.

For example, as is described in JP-A-10-67208 and JP-A-2004-224342, letters engraved or shaped on the surfaces of side walls of a tire as markings are generally made up of solid letters with no rim, double letters, ridge letters within double letters and the like which are provided in such a manner as to project from the side walls, and as this occurs, in a mold for vulcanization molding the tire, corresponding letters are depressed on a molding surface of the mold as engraved letters.

In the case of the markings being made up of the projecting letters or ridges, when a tire was used for a long period of time, cracks were easily produced in the portions where the markings were formed due to strain exerted on the side walls of the tire, or minute foreign particles such as dust and dirt such as oil were accumulated in bottoms of the ridges, whereby the surface or visual appearance of the tire was deteriorated and the visibility of the markings was decreased. Furthermore, there have been caused problems that it is not easy for dust and dirt which is so accumulated in the bottoms of the fine ridges to wash out and that the complicated and troublesome work is necessary to remove scale such as of a parting agent which is deposited in irregularities and bottoms of grooves formed on the mold.

On the other hand, since the manufacturing costs of a mold for vulcanization molding a tire on which the aforesaid letters and patterns are engraved are expensive, a large number of tires of the same type need to be manufactured using one mold, whereby a large number of tires of the same design are sold on the market places.

In recent years, however, there has been among users a strong preference for having things that can be discriminated from those used by others, and also in the field of tires, users have started to seek for tires having original designs based on their demands, and in these situations, it has been almost impossible to meet users' such demands with the tire manufacturing approach described above.

### SUMMARY OF THE INVENTION

The invention was made in view of the problem, and an object there of is to provide inexpensively a pneumatic tire in which markings to be shown on external surfaces of the tire can be produced without depending upon the conventional marking letters, the degree of freedom in designing markings to be shown on the external surfaces of the tire can be enhanced so as to satisfy demands from individual users, and the visibility of such markings can be increased.

The inventor has made every possible effort in studying for a solution to the problem and found that markings could be shown on external surfaces of a tire not by depending upon the conventional approach in which markings were produced by marking letters engraved on a mold but by differentiating a surface roughness of the external surface of the tire between a portion where designed markings were formed and a portion which was finished by a molding surface of the mold.

Namely, according to an aspect of the invention, there is provided a pneumatic tire having markings provided on external surfaces thereof, wherein the markings are formed by affixing thermoplastic resin films of which a center line average surface roughness (Ra) of a surface is in the range of 0.1 to 1.5 μm to predetermined positions on external surfaces of a green tire and then vulcanization molding the green tire.

According to another aspect of the invention, there is provided a method for manufacturing a pneumatic tire having markings provided on external surfaces thereof, including affixing templates made up of thermoplastic resin films which are cut out along contours of the markings and of which a center line average surface roughness (Ra) of a surface is in the range of 0.1 to 1.5 μm to predetermined positions on external surfaces of a green tire and vulcanization molding the green tire in such a state that the templates are affixed thereto using a tire vulcanization mold.

According to a further aspect of the invention, there is provided a method for manufacturing a pneumatic tire having markings provided on external surfaces thereof, including affixing a template made up of a thermoplastic resin film from which the markings are stamped out along contours thereof, which has a background portion of the markings which lies to surround peripheries of the stamped-out portions and of which a center line average surface roughness (Ra) of a surface is in the range of 0.1 to 1.5 μm to a predetermined position on external surfaces of a green tire and vulcanization molding the green tire in such a state that the template is affixed thereto using a tire vulcanization mold.

### BRIEF DESCRIPTION OF THE DRAWINGS

FIG. 1 is a sectional view of a tire of an embodiment which is cut in half,

FIG. 2 is a partial side view of a tire according to first and fourth embodiments,

FIG. 3 is a drawing showing configurations of resin films (templates) according to the first and fourth embodiments,

FIG. 4 is a tire side view showing a state in which the templates of the first and fourth embodiments are affixed to a green tire,

FIG. 5 is a partial side view of a tire according to second and fifth embodiments,

FIG. 6 is a drawing showing a configuration of a resin film (a template) according to the second and fifth embodiments,

FIG. 7 is a tire side view showing a state in which the template of the second and fifth embodiments is affixed to a green tire,

FIG. 8 is a partial side view of a tire according to a third embodiment, and

FIG. 9 is a drawing showing a configuration of a resin film (a template) according to the third embodiment.

### DETAILED DESCRIPTION OF THE INVENTION

Hereinafter, referring to the drawings, embodiments of the invention will be described.

### First Embodiment

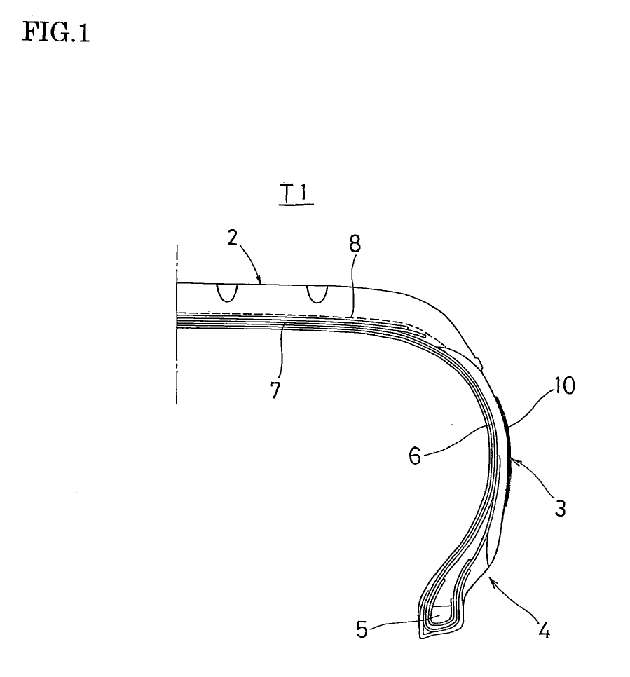

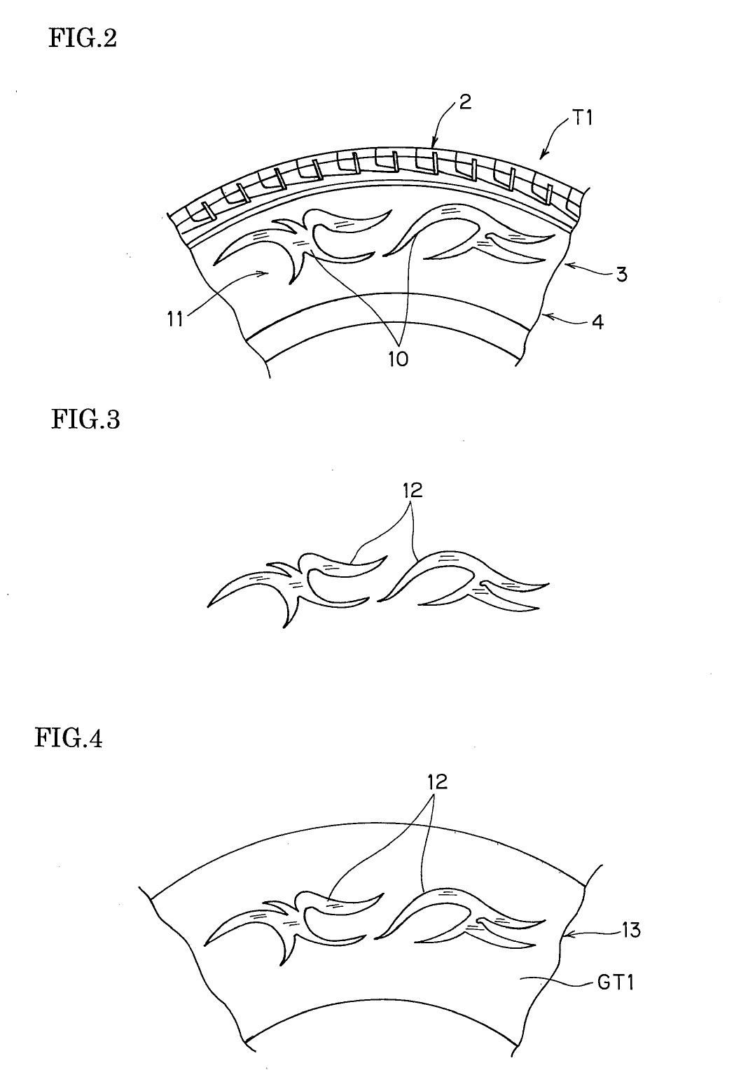

FIG. 1 is a sectional view of a pneumatic tire T1 (hereinafter, the pneumatic tire may simply be referred to as a tire.), cut in half, which constitutes a first embodiment of the invention, and FIG. 2 is a tire side view showing a marking showing portion on an external surface of a side wall portion of the tire.

The tire T1 is made up of a tread portion 2, side wall portions 3 which extend radially inwards from both edges of the tread portion 2, and bead portions 4 which continue to inner edges of the side wall portions 3 and which are secured to rim flanges. In this embodiment, a passenger vehicle radial tire is illustrated as the tire T1 which has a carcass 6 having a radial construction in which edges of carcass plies are turned round bead cores 5, a belt layer 7 which is provided on an outer circumference of the carcass 6 in a portion which corresponds to the tread portion 2 and a belt reinforcement layer 8 which is wound round an outer circumference of the belt layer 7.

Markings 10 are shown on external surfaces of the side wall portions 3 of the fire T1 which are made up of letters, numbers and symbols which show a manufacturer, a trade name, a tire size and the like, as well as graphics which are design patterns which show a rotational direction of the tire and dress up the side portions of the tire. In FIG. 2, as the markings 10, design patterns are shown which dress up the side portions of the tire.

In the tire T1, surfaces of the markings 10 are made up of a specular surface of which a center line average surface roughness (Ra) is in the range of 0.1 to 1.5 μm, and a background portion 11, which surrounds the peripheries of the markings 10, is made up of a rough surface of which Ra exceeds 1.5 μm.

In the tire T1, the markings 10 are formed by affixing thermoplastic resin films 12 shown in FIG. 3 which are cut out along contours of the markings 10 and of which Ra is in the range of 0.1 to 1.5 μm to predetermined positions on side wall portions 13 of a green tire GT1 as is shown in FIG. 4 and vulcanization molding the green tire GT1 within a tire vulcanization molding mold in such a state that the thermoplastic resin films 12 are affixed thereto.

In addition, the background portion 11 is formed into the rough surface by a molding plane of the mold which is adjusted to a surface roughness in which Ra exceeds 1.5 μm, preferably, a surface roughness of which Ra is 2.0 μm or more.

There is imposed no specific limitation on the dimensions of the resin film 12, but it is preferable from the viewpoint of increase in visibility of the markings that the resin film 12 has a radial width of 20 mm or more and a circumferential length of 60 mm or more, so as to have a surface area of 1200 mm² or more.

By this configuration, the light reflectiveness is made to differ between the surfaces of the markings 10 which are made up of the specular surface and the background portion 11 which is made up of the rough surface due to a difference in glossiness therebetween, whereby the markings 10 can be made conspicuous to thereby increase the visibility thereof.

In addition, since different markings can easily be formed on the side wall portions 3 by changing designs of the resin films 12, a tire having markings uniquely designed by the user can be provided from one.

Although the Ra of the specular surface portion is set to the range of 0.1 to 1.5 μm, in the event that the Ra becomes too small, the light reflectiveness at the surfaces of the markings 10 becomes large and hence tends to glitter, whereby the markings 10 sometimes look white so as to decrease the visibility of the markings 10 on the contrary to the intended design. In addition, although mud, oil or the like becomes easy to wash out when they adhere to the marking surfaces, small exterior damage such as a scratch or scrape caused by scratching or scraping with the curb becomes noticeable. In contrast, in the event that the Ra exceeds 1.5 μm or becomes, in particular, 2.0 μm or more, the glossiness at the surface is decreased, the visibility being thereby decreased.

Additionally, the difference in Ra between the surface of the marking 10 which is made up of the specular surface and the surface of the background portion 11 which is made up of the rough surface is preferably 1 μm or more, and more preferably 1.5 μm or more. In the event that the difference is 1 μm or more, there can be obtained a distinct difference in glossiness therebetween, thereby making it possible to enhance the visibility of the marking 10 effectively.

Although no specific upper limit is imposed on the Ra of the rough surface portion, the Ra is preferably less than 3 μm. In the event that the Ra becomes 3 μm or more, the irregularity on the surface is increased to facilitate the intrusion and adhesion of dust or the like thereto, and the surface also gets disadvantageous with respect to resistance to ozone, facilitating the generation of ozone cracks through service over a long period of time.

The center line average surface roughness (Ra) is a center line average roughness of the degree of surface irregularity of an area per unit length which is measured using a contact profile meter in compliance with the provisions of JIS B0601 (a contact profile meter).

In addition, since a portion of the marking 10 is formed to be recessed by an amount equal to the thickness of the film 12 or formed into a recessed flat plane which is recessed inwards, for example, on the order of 0.1 to 1.0 mm in an axial direction of the tire, the problem is solved that cracks are produced in the marking portion which is conventionally provided in such a manner as to be raised or project from the surface of the side wall portion 3 due to repeated application of strain to the side wall portion 3.

In the tire T1, the conventional markings which are provided in such a manner as to be raised or project from the surface of the side wall portion may, of course, be combined with the markings 10.

### Second Embodiment

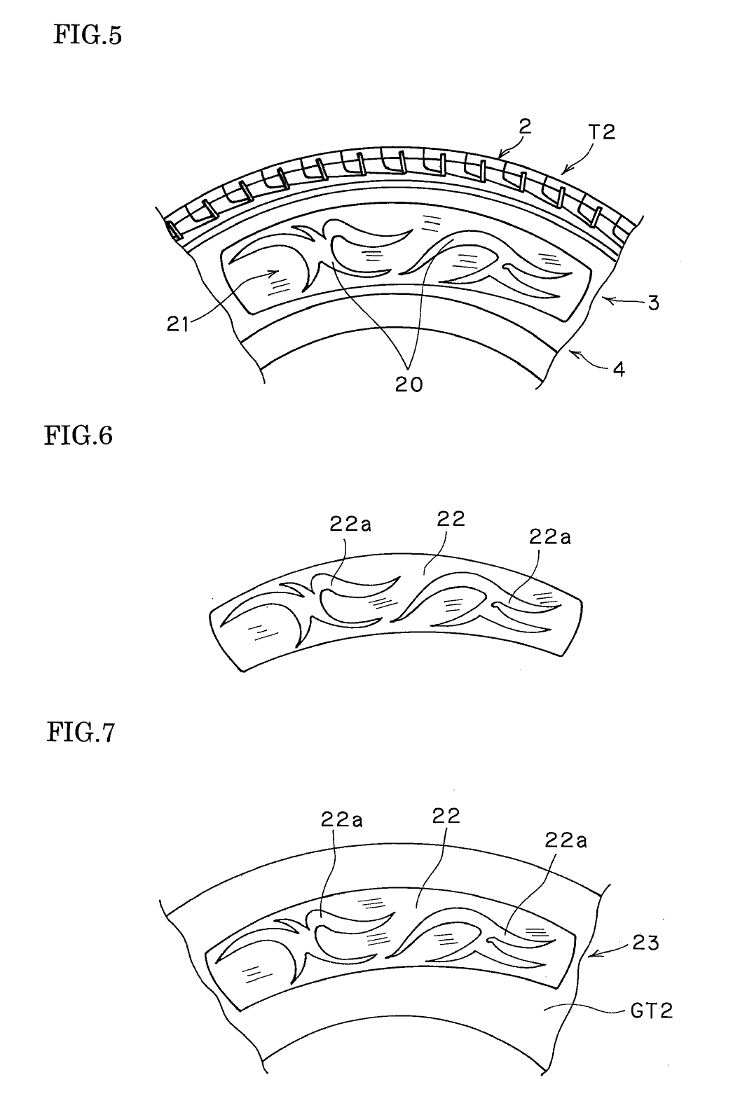

FIG. 5 is a tire side view showing a marking showing portion on an external surface of a side wall portion of a tire T2 which constitutes a second embodiment.

The tire construction of the tire T2 is the same as that of the tire T1 that has been described above, and hence, the description thereof will be omitted.

Markings 20 are shown on external surfaces of the side wall portions 3 of the tire 2 which are made up of letters, numbers and symbols which show a manufacturer, a trade name, a tire size and the like, as well as graphics which are design patterns which show a rotational direction of the tire and dress up the side portions of the tire. In FIG. 5, as the markings 20, design patterns are shown which dress up the side portions of the tire.

In the tire T2, surfaces of the markings 20 are made up of a rough surface of which Ra exceeds 1.5 μm, and a background portion 21, which surrounds the peripheries of the markings 20, is made up of a specular surface of which Ra is in the range of 0.1 to 1.5 μm.

In the tire T2, the markings 20 are formed by affixing a thermoplastic resin film 22 shown in FIG. 6 from which the markings 20 are stamped out along contours thereof, which has a background portion 21 of the markings 20 which lies to surround peripheries of the stamped-out portions 22a and of which Ra of a surface is in the range of 0.1 to 1.5 μm to a predetermined position on side wall portions 23 of a green tire shown GT2 in FIG. 7 and vulcanization molding the green tire in such a state that the thermoplastic film 22 is affixed thereto within a tire vulcanization mold.

In addition, the markings 20 which are formed by the stamped-out portions 22a are formed into the rough surface by a molding plane of the mold which is adjusted to a surface roughness in which Ra exceeds 1.5 μm.

There is imposed no specific limitation on the dimensions of the resin film 22, but it is preferable from the viewpoint of increase in visibility of the markings that the resin film 22 has a radial width of 20 mm or more and a circumferential length of 60 mm or more, so as to have a surface area of 1200 mm² or more.

By this configuration, the light reflectiveness is made to differ between the surfaces of the markings 20 which are made up of the rough surface and the background portion 21 which is made up of the specular surface due to a difference in glossiness therebetween, whereby the markings 20 can be made conspicuous to thereby increase the visibility thereof. Furthermore, since the surface of the side wall portion 3 which surrounds the perimeter of the background portion 21 which is made up of the specular surface can be made to have a different Ra by adjusting the surface roughness of the molding surface of the mold, a marking area which includes the background portion can be made conspicuous further so as to increase the quality of visible or surface appearance of the tire.

In addition, since different markings can easily be formed on the side wall portions 3 by changing designs of the resin films 22, a tire having markings uniquely designed by the user can be provided from one.

Although the Ra of the specular surface portion is set to the range of 0.1 to 1.5 μm, in the event that the Ra becomes too small, the light reflectiveness at the surfaces of the markings 20 becomes large and hence tends to glitter, whereby the markings 20 sometimes look white so as to decrease the visibility of the markings 20 on the contrary to the intended design. In addition, although mud, oil or the like becomes easy to wash out when they adhere to the marking surfaces, small exterior damage such as a scratch or scrape caused by scratching or scraping with the curb becomes noticeable. In contrast, in the event that the Ra exceeds 1.5 μm or becomes, in particular, 2.0 μm or more, the glossiness at the surface is decreased, the visibility being thereby decreased.

Additionally, the difference in Ra between the surface of the marking 20 which is made up of the rough surface and the surface of the background portion 21 which is made up of the specular surface is preferably 1 μm or more, and more preferably 1.5 μm or more. In the event that the difference is 1 μm or more, there can be obtained a distinct difference in glossiness therebetween, thereby making it possible to enhance the visibility of the marking 20 effectively.

Although no specific upper limit is imposed on the Ra of the rough surface portion, the Ra is preferably less than 3 μm. In the event that the Ra becomes 3 μm or more, the irregularity on the surface is increased to facilitate the adhesion of dust or the like thereto, and the surface also gets disadvantageous with respect to resistance to ozone, facilitating the generation of ozone cracks through service over a long period of time.

In addition, since a portion of the background 21 is formed to be recessed by an amount equal to the thickness of the resin film 22 or formed into a recessed flat plane having, for example, a depth of the order of 0.1 to 1.0 mm, the problem is solved that cracks are produced in the marking portion which is conventionally provided in such a manner as to be raised or project from the surface of the side wall portion because the markings 20 are formed on the same plane as the surface of the side wall portion 3 in such a state that the markings 20 look as they were floating from the background portion 21.

In addition, in the tire T2, the conventional markings which are provided in such a manner as to be raised or project from the surface of the side wall portion may, of course, be combined with the markings 20.

### Third Embodiment

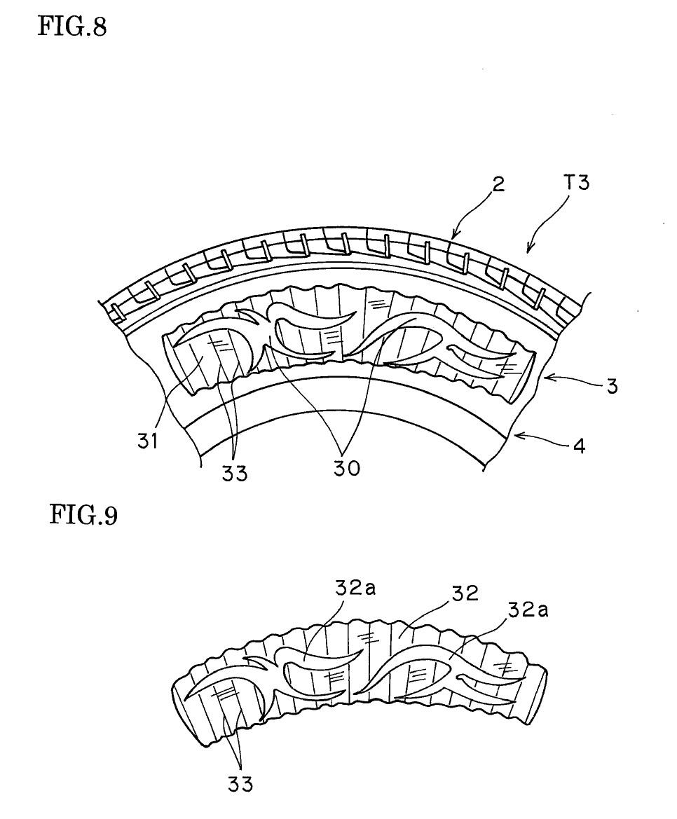

FIG. 8 is a tire side view showing a marking showing portion on an external surface of a side wall portion of a tire T3 which constitutes a third embodiment.

The tire construction of the tire T3 is the same as that of the tire T1 that has been described above, and hence, the description thereof will be omitted.

Markings 30 are shown on external surfaces of the side wall portions 3 of the tire T3 which are made up of letters, numbers and symbols which show a manufacturer, a trade name, a tire size and the like, as well as graphics which are design patterns which show a rotational direction of the tire and dress up the side portions of the tire. In FIG. 8, as the markings 30, design patterns are shown which dress up the side portions of the tire.

In the tire T3, surfaces of the markings 30 are made up of a rough surface of which Ra exceeds 1.5 μm, and a background portion 31, which surrounds the peripheries of the markings 30, is made up of a specular surface of which Ra is in the range of 0.1 to 1.5 μm.

In the tire T3, the markings 30 are formed by affixing a thermoplastic resin film 32 shown in FIG. 9 from which the markings 30 are stamped out along contours thereof, which has a background portion 31 of the markings 30 which lies to surround peripheries of the stamped-out portions 32a and of which Ra of a surface is in the range of 0.1 to 1.5 μm to a predetermined position on the side wall portions of a green tire in a similar manner to that of the second embodiment (refer to FIG. 7) and vulcanization molding the green tire in such a state that the thermoplastic resin film 32 is affixed thereto within a tire vulcanization mold.

As is shown in FIG. 9, a corrugated sheet-like irregular portion 33 is provided in parallel to a radial direction of the tire on the resin film 32, whereby the background portion 31 is formed into the specular surface of which Ra is in the range of 0.1 to 1.5 μm, and at the same time, an irregular pattern is formed by the irregular portion 33.

In addition, the markings 30 which are formed by the stamped-out portions 32a are formed into the rough surface by a molding plane of the mold which is adjusted to a surface roughness of which Ra exceeds 1.5 μm.

There is imposed no specific limitation on the dimensions of the resin film 32, but it is preferable from the viewpoint of increase in visibility of the markings that the resin film 32 has a radial width of 20 mm or more and a circumferential length of 60 mm or more, so as to have a surface area of 1200 mm² or more.

By this configuration, the light reflectiveness is made to differ between the surfaces of the markings 30 which are made up of the rough surface and the background portion 31 which is made up of the specular surface and the irregular pattern due to a difference in glossiness therebetween and furthermore, a synergetic effect of diffuse reflection is provided, whereby the markings 30 can be made more conspicuous to thereby increase the visibility thereof.

Furthermore, since the surface of the side wall portion 3 which surrounds the perimeter of the background portion 31 which is made up of the specular surface can be made to have a different Ra by adjusting the surface roughness of the molding surface of the mold, a marking area which includes the background portion 31 can be made more conspicuous so as to increase the quality of visible or surface appearance of the tire further.

In addition, since different markings and background portions 31 can easily be formed on the side wall portions 3 by changing designs of the resin films 32 and configurations of the irregular portion 33, a tire having markings uniquely designed by the user can be provided from one.

The configuration of the irregular portion 33 is not limited to not only the corrugated sheet-like shape but also a pattern in which peaks and valleys are repeated which are formed into the shape of a polygonal pyramid which includes triangular and quadrangular pyramids, a circular cone or a semi-spherical shape, a checkered pattern, letters and symbols, and the irregular portion 33 can easily be obtained by plasticizing the resin film made of a thermoplastic resin by a hot press, an engraved roll or the like.

Although the Ra of the specular surface portion is set to the range of 0.1 to 1.5 μm, in the event that the Ra becomes too small, the light reflectiveness at the surfaces of the markings 30 becomes large and hence tends to glitter, whereby the markings 30 sometimes look white so as to decrease the visibility of the markings 30 on the contrary to the intended design. In addition, although mud, oil or the like becomes easy to wash out when they adhere to the marking surfaces, small exterior damage such as a scratch or scrape caused by scratching or scraping with the curb becomes noticeable. In contrast, in the event that the Ra exceeds 1.5 μm or becomes, in particular, 2.0 μm or more, the glossiness at the surface is decreased, the visibility being thereby decreased.

Additionally, the difference in Ra between the surface of the marking 30 which is made up of the rough surface and the surface of the background portion 31 which is made up of the specular surface is preferably 1 μm or more, and more preferably 1.5 μm or more. In the event that the difference is 1 μm or more, there can be obtained a distinct difference in glossiness therebetween, thereby making it possible to enhance the visibility of the marking 30 effectively.

Although no specific upper limit is imposed on the Ra of the rough surface portion, the Ra is preferably less than 3 μm. In the event that the Ra becomes 3 μm or more, the irregularity on the surface is increased to facilitate the adhesion of dust or the like thereto, and the surface also gets disadvantageous with respect to resistance to ozone, facilitating the generation of ozone cracks through service over a long period of time.

In addition, since a portion of the background 31 is formed to be recessed by an amount equal to the thickness of the resin film 32 and the irregular portion 33 formed thereon or formed into a recessed plane having, for example, a depth of the order of 0.1 to 1.0 mm, the problem is solved that cracks are produced in the marking portion which is conventionally provided in the projecting fashion because the markings 30 are formed on the same plane as the surface of the side wall portion 3 in such a state that the markings 30 look as they were floating from the background portion 31.

In addition, in the tire T3, the conventional markings which are provided in such a manner as to be raised or project from the surface of the side wall portion may, of course, be combined with the markings 30.

Furthermore, the irregular portion can also be provided on the surface of the marking 10 having the specular surface which has been described in the first embodiment.

### Fourth Embodiment

Next, a method for manufacturing the tire T1 according to the invention will be described by reference to FIGS. 2 to 4.

The tire T1 is manufactured by affixing templates 12 made up of the thermoplastic resin films shown in FIG. 3 which are cut out along contours of the markings 10 to predetermined positions on external surface of the side wall portions 13 of a green tire GT1 and vulcanization molding the green tire GT1 within a tire vulcanization mold in such a state that the templates 12 are so affixed thereto.

The Ra of the markings 10 can be realized by using the thermoplastic films 12 provided with a substantially equal Ra to the surface roughness of the surfaces of the markings in such a way that markings 10 having the same Ra are transferred to the surfaces of the side wall portions during vulcanization, and the background portion 11 can be realized by the mold having a molding surface provided with a substantially equal Ra to the surface roughness of the background portion 11 in such a way that a background portion 11 having the same Ra is transferred to the side wall portions 3 during vulcanization, whereby different glossinesses can be imparted to the marking 10 and the background portion 11.

Namely, the surface roughness (RaF) of the resin film 12 and the surface roughness (RaM) of the molding surface of the mold are transferred to the external surfaces of the tire with substantially the same Ra during vulcanization molding. The resin films 12 can easily be separated and removed from the vulcanized tire after the vulcanization thereof, and the same Ra as that on the surface of the film can be formed on the portions of the markings 10 after the resin films 12 have been removed, and a molded surface having the same Ra as that on the molding surface of the mold can be formed on the background portion 11.

Consequently, engraving letters and designs on the molding surface of the mold, which has been done conventionally, is no more necessary, and this enables tires having different marking designs to be easily manufactured with a single mold, whereby the mold costs can be saved. In addition, since the irregular portions on the molding surface of the mold which are made up of letters and patterns can be eliminated or reduced, maintenance work can be reduced which includes removing scale such as of a parting agent which is deposited in the irregular portions.

Furthermore, since the resin film 12 can easily be separated and removed from the tire, in the event that the films are removed from tires when the tires are delivered to users, the tires can be kept free from damage, dirt and the like which would otherwise be given thereto during storage or transportation.

In addition, since the resin film 12 has the smooth surface, good adhesion can be held with the surface of the green tire GT1 which has the sticking properties, and hence, there occurs no case where the markings 10 are shifted from the predetermined positions during vulcanization. In addition, a rubber solvent may be applied to the surfaces of the green tire GT1 so as to increase the sticking properties.

There is no specific limitation imposed on materials for the thermoplastic resin film 12, and as preferred examples, thermoplastic resins having have melting points equal to or higher than a tire vulcanizing temperature (normally 150 to 160° C.) and superior heat resistance are raised which include, for example, polyester-base resins (PET, PBT, PEN and the like), polyamide-base resins (nylons 6, 66, 12, 46 and the like), polypropylene, polystyrene, polycarbonate, polyvinyl chloride and the like.

In addition, the resin film 12 preferably has superior surface smoothness and a film is preferable which is produced using the biaxial orientation method.

In order to form the surface of the marking 10 into the specular surface, the surface roughness RaF of the resin film 12 is selected from films of which Ra of the surface is in the range of 0.1 to 1.5 μm.

In addition, there is no specific limitation imposed on the thickness of the film 12, and films having a thickness of the order of 0.1 to 1.0 mm, preferably, 0.2 to 0.6 mm are preferable from the viewpoint of handling properties such as film strength, elongation, and suppleness.

As method of cutting the film 12, a method using cutting instruments such as a pair of scissors and cutting knives, a method using laser beams and a method using a stamping machine are raised. Consequently, since one to a countless number of designs can be prepared for the marking 10 and hence a tire having uniquely designed markings can be manufactured from one, different markings can easily be formed on the side wall portions 3 of the tire by changing designs of the templates made up of the resin films 12, so that a tire having markings designed uniquely based on a request by the user can be provided inexpensively from one. In addition, it becomes possible to form markings having complex designs which cannot be obtained by molding using a mold.

There is imposed no specific limitation on the dimensions of the resin film (template) 12, but it is preferable from the viewpoint of increase in visibility of the markings that the resin film 12 has a radial width of 20 mm or more and a circumferential length of 60 mm or more, so as to have a surface area of 1200 mm² or more.

On the other hand, the surface roughness Ra of the background portion 11 is realized by the surface roughness RaM possessed by the molding surface of the mold being transferred to the background portion 11 with substantially the same surface roughness to the side wall portions 3 during vulcanization, and therefore, the surface roughness of the molding surface of the mold may be adjusted to Ra that is required for the surface of the background portion 11. The surface roughness of the molding surface of the mold can be adjusted using the known methods including, for example, electro arc machining, the shot blast method, the specular surface polishing method and a combination thereof.

### Fifth Embodiment

Next, a method for manufacturing the tire T2 according to the invention will be described by reference to FIGS. 5 to 7.

The tire T2 is manufactured by affixing a template 22 made up of the thermoplastic resin film shown in FIG. 6 from which the markings 20 are stamped out along contours thereof and which has the background portion 21 of the markings 20 which lies to surround peripheries of the stamped-out portions 22a to a predetermined position on external surfaces of side wall portions 23 of a green tire GT2 and vulcanization molding the green tire GT2 in such a state that the template 22 is affixed thereto within a tire vulcanization mold.

The Ra of the surface of the background portion 21 of the markings 20 can be realized by using the thermoplastic film 22 provided with a substantially equal Ra to the surface roughness of the surface of the background portion 21 in such a way that a background portion 21 having the same Ra is transferred to the surface of the side wall portion during vulcanization, and the stamped out portions 22a can be realized by the mold having a molding surface provided with a substantially equal Ra to the surface roughness of the stamped out portions 22a in such a way that markings 20 having the same Ra are transferred to the side wall portions 3 during vulcanization, whereby different glossinesses can be imparted to the markings 20 and the background portion 21 thereof.

Namely, the surface roughness (RaF) of the resin film 22 and the surface roughness (RaM) of the molding surface of the mold are transferred to the external surfaces of the tire with substantially the same Ra during vulcanization molding. The resin film 22 can easily be separated and removed from the vulcanized tire after the vulcanization thereof, and the same Ra as that on the surface of the film can be formed on the portion of the background 21 after the resin film 22 has been removed, and the markings 20 having the same Ra as that on the molding surface of the mold can be formed on the stamped out portions 22a.

By this configuration, one to a limitless number of designs can be produced for the marking 20 and hence, a tire having uniquely designed markings can be manufactured from 1, whereby different markings can easily be formed on the side wall portions 3 of the tire by changing designs of the template 22, so that a tire having markings designed uniquely by the user can be provided from one according to a request by the user.

Since the type of the resin film, a method for cutting the same and a method for adjusting the molding surface of the mold of this embodiment are the same as those described in the fourth embodiment, the description thereof will be omitted hereinbelow.

### EXAMPLE

Hereinafter, the invention will be described specifically based on an example, however, the invention is not such as to be limited by the example.

A rubber composition for side wall according to a formulation, which will be described below, was kneaded and prepared using a Banbury type mixer having a capacity of 200 liters in an ordinary manner.

### [Rubber Composition for Side Wall]

•natural rubber (50 parts by weight: RSS#3 made in Thailand), •butadiene rubber (50 parts by weight: BR150B by UBE KOSAN Inc.), •carbon black FEF (60 parts by weight: SEAST SO by Tokai Carbon Inc.), •aromatic oil (10 parts by weight: X-140 by Japan Energy Inc.), •paraffin wax (2 parts by weight: OZOACE-0355 by NIHON SEIRO Inc.), aging preventive agent 6C (2 parts by weight: NOCRAC 6C by OUCHI SHINKO CHEMICAL INDUSTRY Inc.), •stearic acid (2 parts by weight: LUNAC S-20 by KAO Inc.), •zinc oxide (3 parts by weight: AENKA 1 by MITSUI KINZOKU KOGYO Inc.), •sulfur (2 parts by weight: 5% oil treated powder sulfur by HOSOI CHEMICAL INDUSTRY Inc.), •vulcanization promoter NS (1.5 parts by weight: NOCCELER NS-P by OUCHI SHINKO CHEMICAL INDUSTRY Inc.)

Radial tires of 215/60R 16 size were prepared in which the rubber composition so obtained was applied to side wall portions. Sample tires were vulcanization molded under the same vulcanizing conditions by affixing a template made of polyester films (MYLAR A by TEIJIN DuPont Films Inc., 0.3 mm thick, Ra being 0.5 μm) as shown in FIGS. 3 (first embodiment), 6 (second embodiment), 9 (third embodiment, the film was plasticized into the corrugated sheet-like configuration in which peaks were formed to a height of 0.5 mm and at intervals of 5 mm) to predetermined positions on side wall portions of green tires and using a steel tire molding mold. The surface roughness of a molding surface of the mold for molding marking areas on the side wall portions was adjusted by the known electro arc machining, shot blast method and specular surface polishing method so that Ra was in the predetermined range.

Comparison Examples 1 and 2 were molded by a conventional mold in such a way that markings ridged or satinized were formed on surfaces of side walls thereof in such a manner as to project to a height of 1 mm and background portions were satinized. In Comparison Example 3, a molding surface of a mold was formed into a specular surface of which Ra is 0.5 μm. The heights of markings and background portions shown on Table 1 are expressed as from a reference plane which is ±0 mm from the surface of the side wall.

The surface roughnesses Ra of the surface of the marking and the surface of the background portion of the sample tires were measured by the following method, and following this, the sample tires were evaluated by the following methods with respect to marking visibility, visible appearance of the tire after use on a vehicle actually driven, visible appearance after contact with a curb, and visible appearance after use on an ozone illumination drum actually rotated. The results are shown in Table 1.

### [Surface Roughness Ra]

Center line average surface roughnesses Ra of the marking surface and the background portions of the sample tires were measured to the JIS B0601 method using a contact profile meter E-35A by TOKYO SEIMITSU Inc.

### [Marking Visibility]

The side walls of the tires were visually observed by a panel of 10 people. The visibility of the markings were subjected to organoleptic evaluations on the basis of 5 points maximum, and the results of the evaluations averaged out to be rounded to the nearest whole number, the results thereof being shown in Table 1. A larger number indicates a better quality.

### [Visible Appearance After Use on Actually Driven Vehicle]

The sample tires were set on JIS specified rims (with an internal pressure of 220 kPa) and were then fitted on a domestic passenger vehicle of an engine displacement of 2500 cc for an actual running of 3000 km on a general road finished with a dry asphalt road surface. The marking areas were visually observed with respect to dirt and crack generation after use on the vehicle actually so driven and evaluated in the organoleptic fashion on the basis of 5 points maximum. A larger number indicates a better quality.

[Visible Appearance After Contact with Curb]

The sample tires were set on JIS specified rims (with an internal pressure of 220 kPa) and then fitted on a domestic passenger vehicle of an engine displacement of 2500 cc. Then, the vehicle was driven at a vehicle speed of 5 km/h to bring the front tire into contact with a concrete curb at a contact angle of 5 degrees and thereafter, the vehicle was moved 50 cm. Visible appearances of the marking areas of the sample tires were then visually observed and evaluated in the organoleptic fashion on the basis of 5 points maximum. A larger number indicates a better quality.

### [Visible Appearance After Use on Ozone Illumination Drum]

The sample tires were set on JIS specified rims (with an internal pressure of 220 kPa), and a JIS maximum load was exerted on the tires. The tires were rotated on a drum testing machine at 30 km/h for 3 weeks in an atmosphere where ozone concentration was 80 pphm and the temperature was 38° C. Thereafter, the tires were visually observed with respect to ozone crack generation in the marking areas and evaluated in the organoleptic fashion on the basis of 5 points maximum. A larger number indicates a better quality.

TABLE 1

| | COM- | COM- | | | | |
|---|---|---|---|---|---|---|
| | PARISON | PARISON | EMBODI- | EMBODI- | EMBODI- | COMPARISON |
| | EXAMPLE 1 | EXAMPLE 2 | MENT 1 | MENT 2 | MENT 3 | EXAMPLE 3 |
| MARKING (DESIGN PATTERN) | | | | | | |
| MARKING FORMING METHODS | MOLD/AS | MOLD/AS | FILM/AS | FILM/AS FLAT | FILM/AS FLAT | FILM/AS |
| | PROJECTING | PROJECTING | RECESSED | PLANE | PLANE | RECESSED |
| | PLANE | PLANE | PLANE | | | PLANE |
| MARKING HEIGHT (mm) | 1.0 | 1.0 | −0.3 | 0 | 0 | −0.3 |
| MARKING SURFACE | RIDGED | SATINIZED | SPECULAR | SATINIZED | SATINIZED | SPECULAR |
| | | | SURFACE | | | SURFACE |
| MARKING SURFACE ROUGHNESS Ra | 3.5 | 2.0 | 0.5 | 2.0 | 2.0 | 0.5 |
| (μm) | | | | | | |
| BACKGROUND PORTION OF MAKING | | | | | | |
| (PLAIN) | | | | | | |
| BACKGROUND PORTION HEIGHT | 0 | 0 | 0 | −0.3 | −0.3 to −0.8 | 0 |
| (mm) | | | | | | |
| BACKGROUND PORTION SURFACE | SATINIZED | SATINIZED | SATINIZED | SPECULAR | SPECULAR | SPECULAR |
| | | | | SURFACE | SURFACE | SURFACE |
| | | | | | AND | |
| | | | | | IRREGULAR | |
| | | | | | PORTION | |
| BACKGROUND PORTION SURFACE | 2.0 | 2.0 | 2.0 | 0.5 | 0.5 | 0.5 |
| ROUGHNESS Ra (μm) | | | | | | |
| REFERENCE DIAGRAMS | — | — | FIG. 2 | FIG. 5 | FIG. 8 | FIG. 2 |
| MARKING VISIBILITY | 4 | 2 | 5 | 5 | 5 | 2 |
| VISIBLE APPEARANCE AFTER | 1 | 3 | 4 | 4 | 4 | 5 |
| RUNNING | | | | | | |
| VISIBLE APPEARANCE AFTER | 4 | 4 | 4 | 4 | 4 | 3 |
| CONTACT WITH CURB | | | | | | |
| VISIBLE APPEARANCE AFTER | 3 | 3 | 4 | 4 | 4 | 4 |
| OZONE ILLUMINATION | | | | | | |

As is shown by the results indicated on Table 1, it is seen that with the tires of the first to third embodiments according to the invention, not only could superior marking visibility be obtained but also dirt adhesion and crack generation in the marking areas as a result of the actual driving was made as small as possible so that the visible appearance thereof was maintained in good conditions. In addition, exterior damage such as marring given by the curb was made difficult to be made. Furthermore, it is seen that the resistance to ozone crack could be improved by making the surface roughness smaller than that of the conventional satinized area (Comparison Example 1). Thus, it is seen that the visibility of the markings can be maintained in good conditions over a long period of time by the enhancement in visible appearance attained according to the invention.

According to the pneumatic tire of the invention, by differentiating the Ra on the external surfaces of the tire between the molded surface resulting from the vulcanization molding of the green tire in such a state that the thermoplastic resin film of which Ra on the surface is in the range of 0.1 to 1.5 μm is affixed thereto and the molded surface formed by the molding surface of the mold so as to produce the difference in glossiness therebetween to thereby make the markings conspicuous, thereby the visibility thereof being able to be increased. Consequently, engraving letters and designs on the molding surface of the mold in the conventional fashion is made no more necessary, whereby tires having different marking designs can easily be manufactured with a single mold, and hence, not only can the mold costs be saved but also tires having originality desired by the users can be provided inexpensively.

Furthermore, the reduction in visible appearance due to cracks produced by strain exerted on the side walls and dirt made to adhere thereto can be reduced largely, and hence, the maintenance work can also be reduced largely which includes washing of the side walls and cleaning of the mold.

The invention can be applied to pneumatic tires of various sizes and applications which include tires for passenger vehicles and light trucks, and larger tires for buses and heavy trucks.

1. A pneumatic tire having markings provided on external surfaces thereof, wherein the markings are formed by affixing thermoplastic resin films of which a center line average surface roughness (Ra) of a surface is in the range of 0.1 to 1.5 μm to predetermined positions on external surfaces of a green tire and then vulcanization molding the green tire.

2. A pneumatic tire as set forth in claim 1, wherein surfaces of the markings are made up of a specular surface of which Ra is in the range of 0.1 to 1.5 μm and a background portion surrounding peripheries of the markings is made up of a rough surface of which Ra exceeds 1.5 μm.

3. A pneumatic tire as set forth in claim 1, wherein surfaces of the markings are made up of a rough surface of which Ra exceeds 1.5 μm and a background portion surrounding peripheries of the markings is made up of a specular surface of which Ra is in the range of 0.1 to 1.5 μm.

4. A pneumatic tire as set forth in any of claims 1 to 3, wherein the markings are provided on side wall portions of the tire.

5. A pneumatic tire as set forth in any of claims 1 to 3, wherein a difference in Ra between the specular surface portion and the rough surface portion is 1 μm or more.

6. A pneumatic tire as set forth in any of claims 1 to 3, wherein an irregular portion is formed on at least part of the surfaces of the markings and/or the surface of the background portion.

7. A method for manufacturing a pneumatic tire having markings provided on external surfaces thereof, comprising affixing templates made up of thermoplastic resin films which are cut out along contours of the markings and of which Ra of a surface is in the range of 0.1 to 1.5 μm to predetermined positions on external surfaces of a green tire and vulcanization molding the green tire in such a state that the templates are affixed thereto using a tire vulcanization mold.

8. A method for manufacturing a pneumatic tire having markings provided on external surfaces thereof, comprising affixing a template made up of a thermoplastic resin film from which the markings are stamped out along contours thereof, which has a background portion of the markings which lies to surround peripheries of the stamped-out portions and of which Ra of a surface is in the range of 0.1 to 1.5 μm to a predetermined position on external surfaces of a green tire and vulcanization molding the green tire in such a state that the template is affixed thereto using a tire vulcanization mold.

9. A method for manufacturing a pneumatic tire as set forth in claim 7 or 8, wherein the position where the template is affixed is on side wall portions of the tire.

10. A method for manufacturing a pneumatic tire as set forth in any of claims 7 to 8, wherein at least part of the template made up of the thermoplastic resin film is plasticized to provide an irregular portion.

11. A method for manufacturing a pneumatic tire as set forth in claim 9, wherein at least part of the template made up of the thermoplastic resin film is plasticized to provide an irregular portion.

12. A pneumatic tire as set forth in claim 4, wherein a difference in Ra between the specular surface portion and the rough surface portion is 1 μm or more.

13. A pneumatic tire as set forth in claim 4, wherein an irregular portion is formed on at least part of the surfaces of the markings and/or the surface of the background portion.

14. A pneumatic tire as set forth in claim 5, wherein an irregular portion is formed on at least part of the surfaces of the markings and/or the surface of the background portion.
